(19) United States
(12) Patent Application Publication
(10) Pub. No.: US 2005/0075899 A1
(43) Pub. Date: Apr. 7, 2005

(54) Global cargo container information clearinghouse

(76) Inventors: Timothy M. Corcoran, Oakton, VA (US); John S. Radzikowski, Falls Church, VA (US)

Correspondence Address: ANDREWS KURTH LLP;Intellectual Property Department, Suite 300, 1701 Pennsylvania Avenue, N.W., Washington, DC, 20006, US

(21) Appl. No.: 10/781,619

(22) Filed: Feb. 20, 2004

Related U.S. Application Data
(60) Provisional application No. 60/508,277, filed on Oct. 6, 2003.

(51) Int. Cl. G06F 17/60

(52) U.S. Cl. 705/1

(57) ABSTRACT

A Global Cargo Container Information Clearinghouse (GCCIC) provides a public-private partnership in which private sector parties involved in the manufacture; transport and supply of products work in conjunction with government agencies to effect the secure and rapid flow of goods across national borders.

### CROSS REFERENCE TO RELATED APPLICATION(S)

This application claims priority of provisional application No. 60/508,277, filed Oct. 6, 2003, entitled “CARGO CONTAINER INFORMATION CLEARINGHOUSE,” of which the subject matter is herein incorporated by reference in its entirety.

### TECHNICAL FIELD

The technical field is systems and methods that provide for efficient and secure transportation of cargo over and within national borders.

### BACKGROUND

Cargo containers are large, generally rectangular boxes that are used to move cargo over sea on ships, and over land on flatbed or specially designed trucks, rail, and air. Approximately ninety percent of the world's cargo moves in these cargo containers. Each year, over 48 million full cargo containers move between the world's major seaports. Each year, more than 16 million cargo containers arrive in the United States. Each year, U.S. Customs processes over 25 million entries. And each year, more than 1.2 trillion dollars in imports pass through U.S. ports of entry. Despite, or perhaps because of, this large trade volume, the shipping industry lacks an integrated and effective accountability system for cargo containers.

The lack of integration and accountability raised new concerns after the terrorist attacks of September 11. In response to these attacks, U.S. Federal agencies developed or modified numerous programs and systems to improve security and accountability of manufacturing, transportation, personnel and supply chains with respect to movement of cargo containers and people into and out of the United States. These programs include:
Operation Safe Commerce
Container Security Initiative,
Free and Secure Trade Program,
Smart and Secure Travel Lanes,
Smart and Secure Travel Lanes (SSTL),
Sea Cargo Targeting Initiative,
NEXUS,
USVISIT (Entry-Exit),
Electronic Supply Chain Manifest System,
Land Border Carrier Initiative Program (LBCIP),
Customs Trade Partnership Against Terrorism (C-TPAT),
E-Government Strategy Initiatives,
International Trade Data System (ITDS),
Automated Commercial Environment (ACE),
Transportation Worker Identification Credential (TWIC), and
Border Release Advanced Selectivity System (BRASS).

### SUMMARY

What is disclosed is a Global Cargo Container Information Clearinghouse (GCCIC), which includes a mutual benefit association operated on behalf of commercial entities and government agencies involved in the movement of cargo containers across national borders. The GCCIC also includes a GCCIC system that provides the status of cargo containers and other information and products to selected parties in the chain of custody from point of origin to port of entry and beyond, and that provides the same or other information to other entities, including government agencies, concerned with the movement of cargo containers. As part of the GCCIC system, a central information repository maintains records of cargo container physical location and integrity as well as virtual records of documents and approvals associated with a given shipment transaction. The GCCIC accepts records in a range of electronic formats as selected by the subscribing entity (e.g. manufacturer, shipper, non-vessel owner, etc.). A database of cargo container transactions, associated business, legal, and security information that allows both the private sector and governments to analyze patterns of cargo container movement and the status of individual cargo containers.

In the GCCIC association, commercial entities operate in partnership with government agencies to manage a GCCIC program and to establish governing and operating rules for roles, responsibilities, performance and liabilities of entities using the GCCIC system. To ensure the efficient operation of the GCCIC, a GCCIC operating entity (OE) performs management and maintenance functions. The GCCIC OE ensures the GCCIC association provides its members with assistance and information to result in the highest efficiency and lowest risk possible when shipping goods in cargo containers. The GCCIC association establishes, with the concurrence of government agencies, as appropriate, sets of governing rules and operating rules for the movement of cargo containers across national borders. Commercial entities in the chain-of-custody that subscribe to the rules have a “branded” shipment transaction as well as an opportunity to insure the transaction. A branded transaction improves the speed, completeness and confidence in the integrity of a given transaction, thus lowering the risk exposure of each party involved in the trade transaction.

Members of the GCCIC association include, among others, manufacturers, shippers, terminal operators, brokers, port authorities, retailers, banks and insurers. U.S. Federal and other governments may participate in the development of GCCIC governing and operating rules and may incorporate the rules by reference in trade regulations and in other regulations as needed.

The GCCIC program offers the transportation, supply chain, banking, and insurance industries a comprehensive clearinghouse service that provides:
Transaction and data repository services, customized GCCIC program services, and products to participating industry members on an annual membership and transaction fee basis;
Information on major aspects of the ownership, physical integrity, location, approvals and transaction records associated with the cargo container chain of custody.
A single commercial sector reporting interface to applicable Government systems, including International Trade Data System (ITDS) and Automated Commercial Environment (ACE);
Regulatory reporting to the U.S. Government that complies with commerce, transportation, financial, product and commodity requirements based on industry rules developed through a formal public-private partnership, in the form of the Global Cargo Container Information Clearinghouse association;
Syndication of risk, investment and liability for participating GCCIC members; and
Enhanced security of competitive business data and improved business efficiencies.

The GCCIC association remes the market need for a commercially viable program that allows businesses to both comply with Government border security requirements and cost-effectively enhance their business operations.

### DESCRIPTION OF THE DRAWINGS

The detailed description will refer to the following drawings in which like numerals refer to like objects, and in which:

FIG. 1A is a block diagram of an embodiment of a Global Cargo Container Information Clearinghouse (GCCIC), including a GCCIC association;

FIG. 1B illustrates features of the GCCIC of FIG. 1A;

FIG. 2 is a block diagram showing additional features of the GCCIC of FIG. 1A;

FIG. 3 is a block diagram of GCCIC rules of the GCCIC of FIG. 1A;

FIG. 4A is a block diagram of the enforcement mechanism of the GCCIC of FIG. 1A;

FIG. 4B is a block diagram of the GCCIC initiatives and programs of the GCCIC of FIG. 1A;

FIG. 5 illustrates a possible movement of a cargo container in the GCCIC of FIG. 1A;

FIG. 6 is a flowchart of an operation of the GCCIC of FIG. 1A;

FIG. 7 is a block diagram of one embodiment of a GCCIC system used by the GCCIC of FIG. 1A;

FIG. 8 is a flowchart of a transaction covered by the GCCIC of FIG. 1A;

FIG. 9 illustrates a standard cargo container used by members of the GCCIC of FIG. 1A;

FIGS. 10A-10C illustrate features of an improved cargo container; and

FIGS. 11A-11C illustrate routines executed by the GCCIC system of FIG. 7.

### DETAILED DESCRIPTION

A Global Cargo Container Information Clearinghouse (GCCIC) association provides a public-private partnership wherein private sector parties involved in the finance, insurance, manufacture, transport and supply of products work in conjunction with government agencies to develop rules and guideline to effect the secure and rapid flow of goods across national borders.

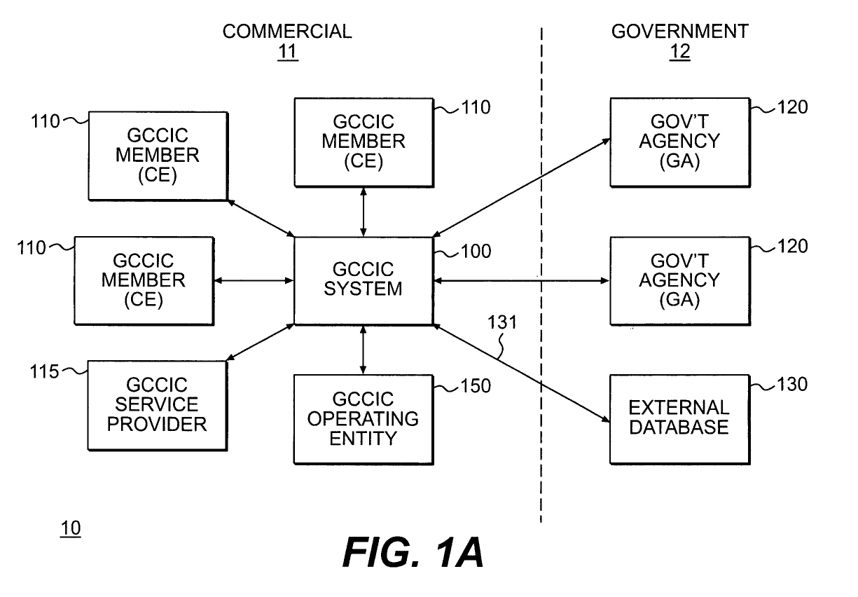

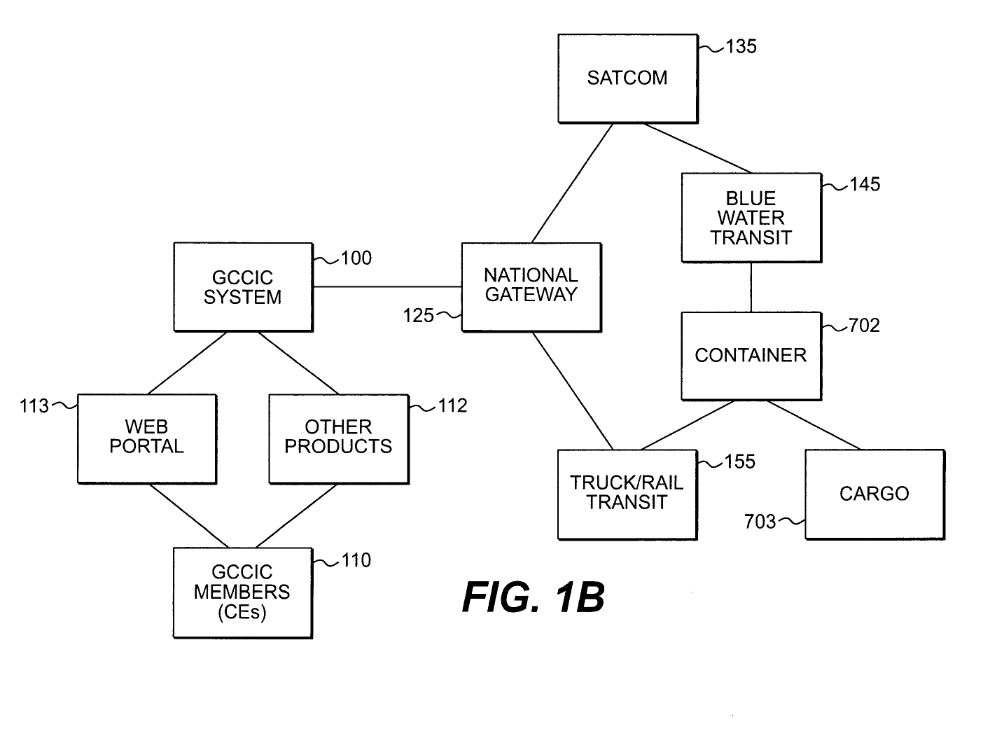

FIG. 1A is a block diagram of a GCCIC 10 that provides international and domestic transportation, supply chain, banking, and insurance industries with a comprehensive cargo container clearinghouse service that is based on mutually accepted rules and a program of incentives and products that encourages members of the GCCIC 10 to conform to the rules. The GCCIC 10 includes a GCCIC association, which is a not-for-profit organization and includes commercial entities and may include government agencies. The GCCIC includes a commercial side 11 and a government side 12. The commercial side 11 includes commercial entities (CEs) 110 that are involved in international trade. The government side 12 includes government agencies (GAs) 120 that are responsible for policy, regulatory, and security aspects of international trade, national trade, and national security. The CEs 110 and GAs 120, at their discretion, form the GCCIC association.

The GCCIC 10 is centered around a GCCIC system 100 that includes information and processing capabilities used by members of the GCCIC 10. The GCCIC 10 is operated by GCCIC operating entity (OE) 150. The GCCIC system 100 may be operated through the GCCIC OE 150 by GCCIC service provider 115.

The GCCIC 10 may include links 131 to external databases and information repositories, such as external database 130. Although the external database 130 is shown on the government side 12, other external databases 130 may reside on the commercial side 11.

The CEs 110 may propose rules for operation of the GCCIC 10 and GCCIC system 100 and the GAs 120 may incorporate the rules into their individual regulatory schemes. The result of the collaboration between CEs 110 and GAs 120 is a mutually beneficial association that provides governance and rule making for cargo container transactions and associated business and system processes.

The CEs 110 may be any commercial entity associated with the manufacture, sale, supply, and transport of goods, particularly when those goods are transported across borders in cargo containers. Examples of CEs 110 are manufacturers, wholesalers and retailers, shippers, carriers, freight forwarders, non-vessel owner common carriers (NVOCCs), financial institutions, insurance companies, other inter modal transport companies, airlines, trucking companies, and rail companies. The CEs 110 pay a set amount for their annual membership in the GCCIC 10. Additionally, the CEs 110 may pay an annual subscription to the GCCIC OE 150. Alternatively, or in addition, the CEs 110 may pay a per transaction fee to GCCIC OE 150.

The GAs 120 may be any U.S. government agency including U.S. Federal, State and local agencies, and corresponding foreign government agencies, that are responsible for transportation of goods, border security, and other aspects of national security. Examples of GAs 120 are the U.S. Coast Guard and Department of Treasury.

The GCCIC OE 150 is a for-profit entity that, as an active member of the GCCIC 10, provides transaction and data services, analytical and information services, risk management services, insurance, and technology products and capabilities to the CEs 110 either directly or through third party providers. The GCCIC OE 150 may also perform management functions for the GCCIC 10, and may act as a government liaison. The GCCIC OE 150 may receive a percentage of the fees paid by the CEs 110.

The GCCIC system 100 supports reporting, tracking and accountability of cargo containers within multiple modes of transportation systems, for both international and U.S. domestic markets. The GCCIC system 100 provides a single reporting interface to such Government systems as the Automated Commercial Environment (ACE) and the International Trade Data System (ITDS). For example, through the ACE program, the GA 120 reports information to CEs 110 through the GCCIC system 100, forwards data from the GCCIC 100 to other cognizant government security agencies, and receives and processes cargo transport security and clearance data. Through the ITDS, the GA 120 receives, processes and disseminates import and export regulatory data, forwards the data to other cognizant regulatory agencies, and reports information back to CEs 110 using the GCCIC system 100. The GCCIC system 100 implements these reporting requirements in accordance with the rules established by the GCCIC 10. CEs 110 use the GCCIC system 100 to effect Government compliant trade transaction reporting and account for cargo containers within multiple modes of transportation, for both international and domestic markets.

The GCCIC system 100 processes data relayed from cargo containers using, for example, a radio frequency tag network (not shown in FIG. 1A) As will be described later in detail, the tag network includes electronic tags associated with a cargo container. The electronic tags gather information related to their associated cargo containers, and communicate the information to the GCCIC system 100 using various communications mechanisms including satellite communications.

GCCIC service provider 115 operates in conjunction with the GCCIC OE 150 to provide technical advice, account management, transaction and payment processing, service delivery, and hardware and components to be used when operating within the GCCIC 10. For example, the service provider 115 provides RFID tags for use with cargo containers. The RFID tags may be sold or leased to members of the GCCIC association. The service provider 115 maintains the RFID tags, provides technical updates to the tags, provides tag repair and service, and provides instructions and training to GCCIC association members for use of the RFID tags. The service provider 115 may be a different commercial entity from the GCCIC OE 150.

FIG. 1B illustrates features of the GCCIC 10. As shown, GCCIC members (CEs) 110 communicate with the GCCIC system 100 using Web portal 113. Using the Web portal 113, CEs 110 can access data in the GCCIC system 100 information repository, can send data (forms, records, and shipping-related data) to the GCCIC system 100, and can receive data and reports distributed by the GCCIC system 100. Although only Web portal 113 is shown in FIG. 1B, the GCCIC 10 includes other communications mechanisms, including facsimile, telephone, mail, and any other means for receiving and sending data and reports. The GCCIC system 100 also provides other products 112 to members of the GCCIC association. These other products 112 and use of the Web portal 113 will be described in detail later.

The GCCIC system 100 is designed to receive information directly from cargo containers, such as cargo container 702 containing cargo 703 using a tag network. A national information gateway 125 provides a communication link between the GCCIC system 100 and the cargo container 702 and its associated electronic tag. For example, when cargo container 702 is in blue water transit 145, data from the cargo container 702 can be sent to the GCCIC system 100 using satellite communications (SATCOM) system 135 and national gateway 125. Similarly, when cargo container 702 is in truck or rail transit 155, data from the cargo container 702 can be sent to the GCCIC system 100 using, for example, wireless communications such as the Internet and national gateway 125. Alternatively, when cargo container 702 is in truck or rail transit 155, data from cargo container 702 may be sent using the satellite communications system 135. Data that may be sent from the cargo container 702 to the GCCIC system 100 will be described in detail later.

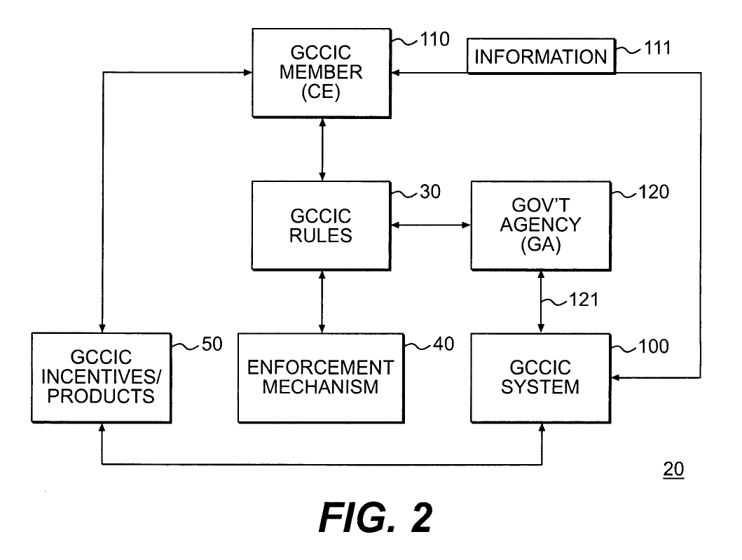

FIG. 2 is a block diagram showing other features 20 of the GCCIC 10. As shown, the CE 110 provides information 111 to the GCCIC system 100. The information 111 may be background information related to the CE 110 and its employees and associated companies. The information 111 will be described in detail later. The CE 110 also conforms its activities to a set of mutually approved GCCIC rules 30. The GCCIC rules 30 may be incorporated by reference into the regulatory scheme of the GA 120. The GA 120 can access the information and services provided in the GCCIC system 100 using interface 121. Alternatively, the GA 120 can access the GCCIC system 100 using Web portal 113 shown in FIG. 1B. An enforcement mechanism 40 exists to help ensure compliance by the CE 110 with the GCCIC rules 30. Finally, a set of GCCIC incentives and programs 50 is available to the CE 110 to encourage the CE 110 to conform its activities to the GCCIC rules 30. Although membership in the GCCIC 10 is voluntary, once the GCCIC rules 30 are acknowledged by a GA 120 as part of the GA's regulatory scheme, compliance with the rules may be mandatory. However, the manner in which the CE 110 complies with the mandatory rules may be further specified in the GCCIC rules 30.

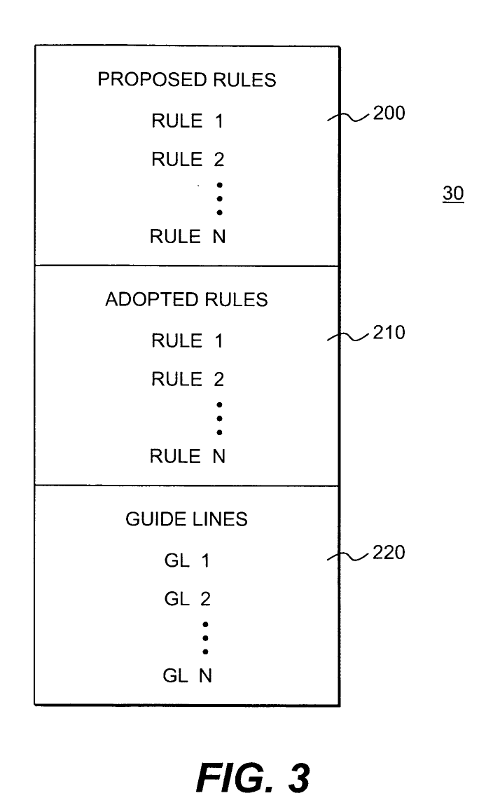

FIG. 3 is a block diagram of the GCCIC rules 30. The GCCIC rules 30 apply to governance of the GCCIC association and operation of the GCCIC 10. The GCCIC rules 30 include a set of proposed rules 200, a set of adopted rules 210, and guidelines 220. The proposed rules 200 are rules proposed by one or more of the CEs 110, or by the GCCIC OE 150, and agreed to by a majority of the CEs 110. Compliance with the proposed rules 200 is mandatory on the part of the CEs 110 by virtue of their membership in the GCCIC association. The adopted rules 210 are previously proposed rules 200 that have been adopted with or without modification, and may be acknowledged by a GA 120. Acknowledgement of rules by the GA 120 may be by incorporation by reference. CEs' 110 compliance with the adopted rules 210 is mandatory by virtue of their incorporation into the GCCIC's operating rules. The guidelines 220 are suggestions to improve cargo container practices, but are not mandatory on the CEs 110. However, compliance with the guidelines 220 may result in reduced shipping expenses and other benefits to the CEs 110. The guidelines 220 may eventually become proposed rules 200 and adopted rules 210.

An example of proposed rules 200 includes: Rule 1: “All products to be transported must be stored in bonded warehouses.” If some products were not so stored, a cargo container carrying such products may be assigned a higher risk rating, and insurance rates for transporting the cargo container could be increased. Many other rules may exist that, if followed, will result in lower insurance rates and a greater likelihood of avoiding costly delays at ports of entry due to, for example, lengthy customs inspections.

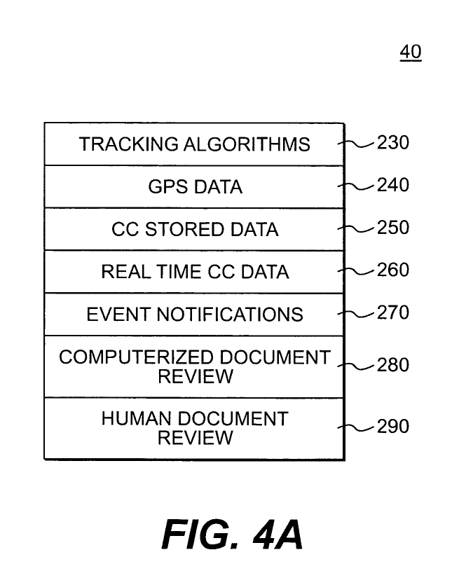

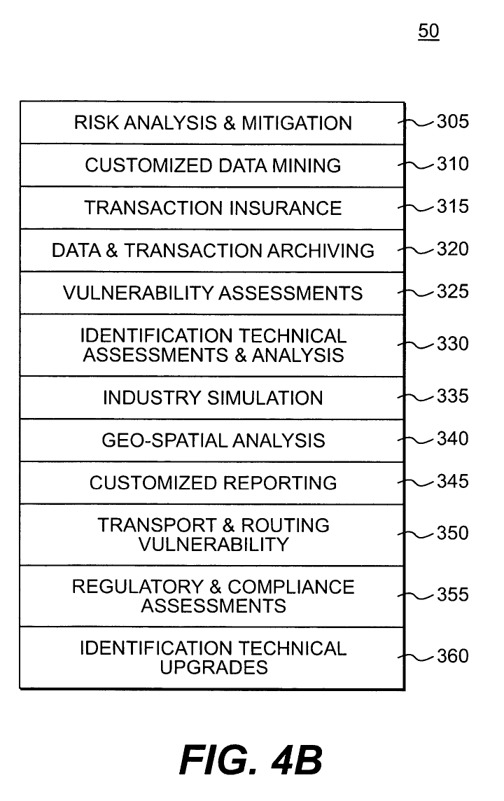

FIG. 4A is a block diagram of the enforcement mechanism 40. The enforcement mechanism 40 may rely on direct monitoring of a cargo container and collection of data from that cargo container. The enforcement mechanism 40 may also include computerized and human review of records associated with the movement of a cargo container. As shown in FIG. 4A, specific enforcement mechanisms that rely on monitoring and data collection include tracking algorithms 230, global positioning satellite (GPS) data 240, cargo container stored data 250, real time cargo container data 260, and event notifications 270. To implement any of the specific enforcement mechanisms 230, 240, 250, 260, and 270, the GCCIC 10 may implement specific features such as smart containers, GCCIC data processing and reporting, and other features. These additional features will be described in detail later. The specific enforcement mechanisms that involve review of records include computerized document review 280 and human-based document review 290. To implement the computerized document review 280, the GCCIC 10 may also implement GCCIC data processing and reporting.

To encourage membership in the GCCIC 10, and compliance with its rules and guidelines, the GCCIC 10 provides a number of unique and valuable products and services that justify the cost of membership. These products and services include:
Cargo transaction record processing and accountability for CEs 110.
Cargo and container insurance transaction processing.
Accountability of legal custody and ownership of cargo and containers.
Transformation of cargo and container data into useable data processing formats and Government compliant reporting/transaction formats, as needed by GCCIC association members.
Risk management and assessment of cargo container risk levels.
Creation and recording of rules and guidelines affecting the processing of cargo container record transactions.
Storage, retrieval and analysis of cargo container and trade related data and transactions.

FIG. 4B is a block diagram of the GCCIC initiatives and programs (GCCIC I/P) 50. The GCCIC I/P 50 are intended to encourage GCCIC membership, and to encourage CEs 110 to comply with the proposed and adopted rules 200 and 210, and to follow the guidelines 220. The GCCIC IP 50 include a risk analysis and mitigation module 305, a customized data mining module 310, a transaction insurance module 315, a data and transaction archiving module 320, a vulnerability assessment module 325, an identification technical assessments and analysis module 330, an industry simulation module 335, a geo-spatial analysis module 340, a customized reporting module 345, a transport and routing module 350, a regulatory and compliance assessments module 355, and an identification technical upgrades module 360.

The risk analysis and mitigation module 305 includes an analysis of the risk associated with transporting particular goods in a specific cargo container along an intended transportation route. The risk analysis may be reported to appropriate members of the GCCIC and may be used to set insurance rates, or schedule cargo inspections, for example. The risk assessment module 305 is also capable of suggesting risk mitigating actions that may be taken by one or more of the GCCIC association members in order to reduce risk and thereby lower insurance rates.

The customized data mining module 310 allows GCCIC association members to query data in the data repository in order to determine optimum transport routing, features and performance histories of association members, and other data that may be usable to make cargo transport more efficient, risk mitigated, and less costly.

Transaction insurance module 315 matches beneficial owners with insurance carriers, and based on a risk assessment, provides possible insurance options for the transport of cargo in cargo containers.

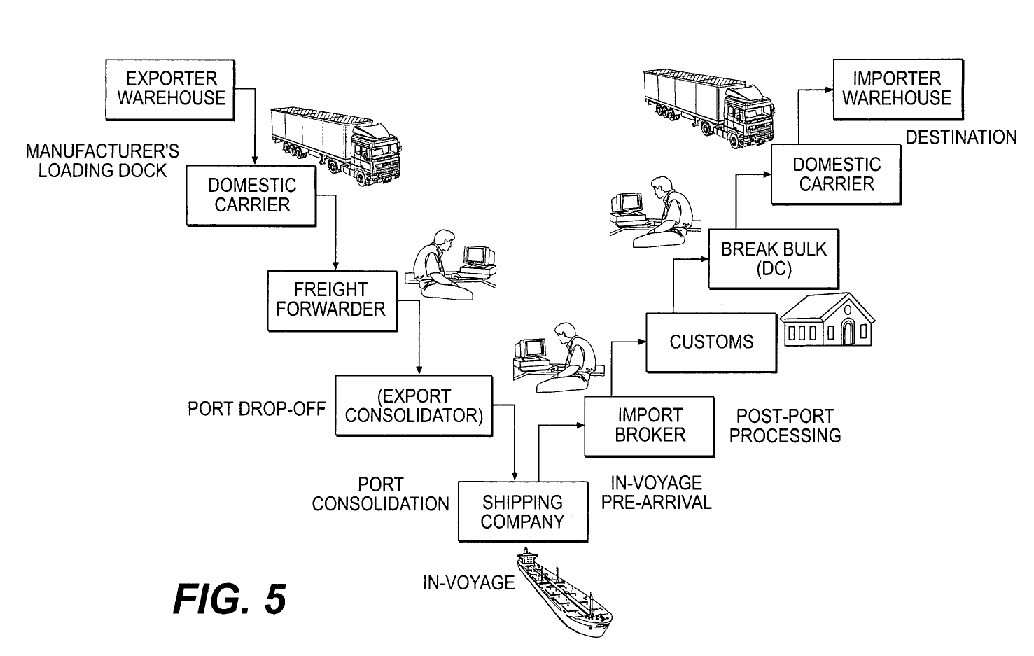

FIG. 5 illustrates a possible (and simplified) movement of cargo and a cargo container using the features and services of the GCCIC 10. Cargo to be shipped from a manufacturer (exporter) to a final destination (importer) is first packaged at an exporter's warehouse and then is picked up at the exporter's loading dock by a domestic carrier. Such pick up is typically by truck as illustrated. The cargo may be packetized and palleted for ease in handling. The domestic carrier transports the cargo to a freight forwarder for preparation of documents associated with export of the cargo. The cargo is then dropped at a port for consolidation by an export consolidator, where the cargo is placed in an appropriate cargo container. A shipping company takes custody of the cargo container and loads it onto a ship for at-sea transit (in-voyage).

As the ship nears port, an import broker reviews the documents associated with the arriving cargo and completes necessary pre-arrival data processing and reporting. The import broker will also ensure all post cargo unloading reporting is completed. The unloaded cargo may be held in a bonded warehouse awaiting completion of customs inspection and processing. Following customs clearance, a domestic carrier may transport the cargo (break bulk, meaning the cargo is broken out from other cargo in the cargo container) to its destination at the importer's warehouse.

As shown in FIG. 5, many different entities, including commercial entities and government agencies, play a role in the transport and processing of the cargo from the exporter's warehouse to the importer's warehouse. At each point along the transport route, these entities may be required by government regulations and commercial contracts to make reports or fill out documents, such as a cargo declaration, for example. Using the GCCIC 10, these same entities may provide the required data to the GCCIC system 100. The thus-provided data is then available to other entities in the transport chain, including government agencies such as the customs services. The GCCIC's operating and governing rules specify what data and reports are required to be made to the GCCIC system 100.

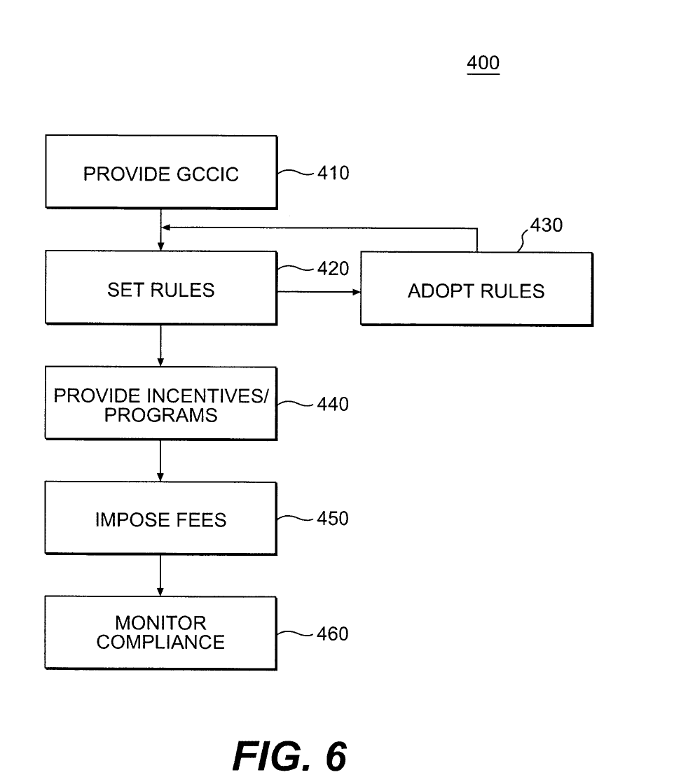

FIG. 6 is a flowchart of an operation 400 of the GCCIC 10. The operation 400 begins in block 410 with the GCCIC OE 150 providing the GCCIC system 100 and signing up commercial entities as CEs 110. The GCCIC 10, its CEs 110, and the GCCIC OE 150 then develop an initial set of proposed rules 200 and adopted rules 210 to guide the activities of the GCCIC association (block 420). The adopted rules 210 are provided to appropriate GAs 120, which may acknowledge the adopted rules 210 and incorporate them by reference into the GAs' regulatory schemes (block 430). The adopted rules 210 are provided in the GCCIC association (block 420). In block 440, the GCCIC OE 150 provides, or facilitates provision of, a set GCCIC initiatives and programs (e.g., the GCCIC I/P 50 of FIG. 4B). In block 450, the GCCIC OE 150 imposes fees on the CEs 110. The imposed fees provide the operating expenses of the GCCIC 10 and provide profits for the GCCIC OE 150. Finally, in block 460, the GCCIC OE 150 monitors compliance with the proposed and adopted rules 200 and 210 and guidelines 220.

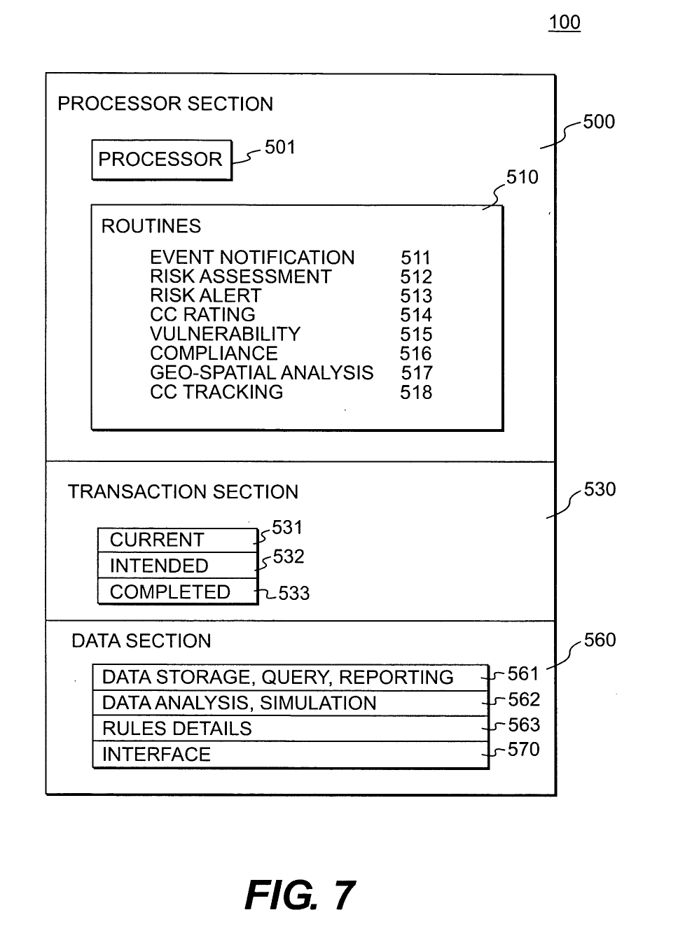

FIG. 7 is a block diagram of one embodiment of the GCCIC system 100. As implemented, the GCCIC system 100 may include software routines, data storage, and hardware devices. The GCCIC system 100 may be implemented at a single site or location. Alternatively, the GCCIC system 100 may be implemented at a number of dispersed sites. In yet another alternative arrangement, some functions of the GCCIC system 100 may be implemented at one site, while other functions are implemented at other sites.

The GCCIC system 100 includes a processor section 500, a transaction section 530, and a data section 560. The processor section 500 includes a processor 501 that executes supplied software routines 510 using data from the data section 560, and data from external sources, such as the external source 130 of FIG. 1A. The supplied software routines 510 include algorithms that allow the GCCIC system 100 to provide, or to facilitate the provision of, the GCCIC I/P 50 shown in FIG. 4B. More specifically, the software routines 510 include event notification algorithm 511, risk assessment algorithm 512, risk alert algorithm 513, cargo container rating algorithm 514, vulnerability algorithm 515, compliance algorithm 516, geo-spatial analysis algorithm 517, cargo container tracking algorithm 518, and other algorithms. These algorithms 511-518 will be described in detail later.

The transaction section 530 includes information related to transactions among the CEs 110. A current transaction section 531 provides information related to a transaction that has been initiated, but not completed. An intended transaction section 532 provides information related to transactions that have been planned, but not initiated. A completed transaction section 533 provides information related to transactions that have been completed. The information related to these three types of transactions will be described later in detail.

The data section 560 includes routines 561 for data storage, query, reporting and archiving. The data section 560 also includes routines 562 for data analysis, simulation and modeling, and data visualization. Finally, the data section 560 includes details 563 of the proposed rules 200, the adopted rules 210, and the guidelines 220.

The data section 560 also includes a data interface 570 that allows CEs 110 and GAs 120 to input data into the GCCIC system 100, through the Web portal 113 shown in FIG. 1B, or though another input mechanism, to query the GCCIC system 100, and to receive information from the GCCIC system 100. The data interface can also accept data directly from cargo containers using national gateway 125 shown in FIG. 1B. The data interface 570 may implement wireless technology and satellite technology such that the GCCIC system 100 may receive wireless data transmissions and transmissions for satellite systems. The data interface 570 allows for receipt of GPS data from cargo containers and vehicles and vessels associated with the cargo containers. The data interface 570 also allows for receipt of information over communications networks, by facsimile, by mail and other hard copy transmission, and for manual entry (e.g., by keyboard). Information is provided by the data interface 570 by electronic means such as e-mail and Internet, and by facsimile and hard copy.

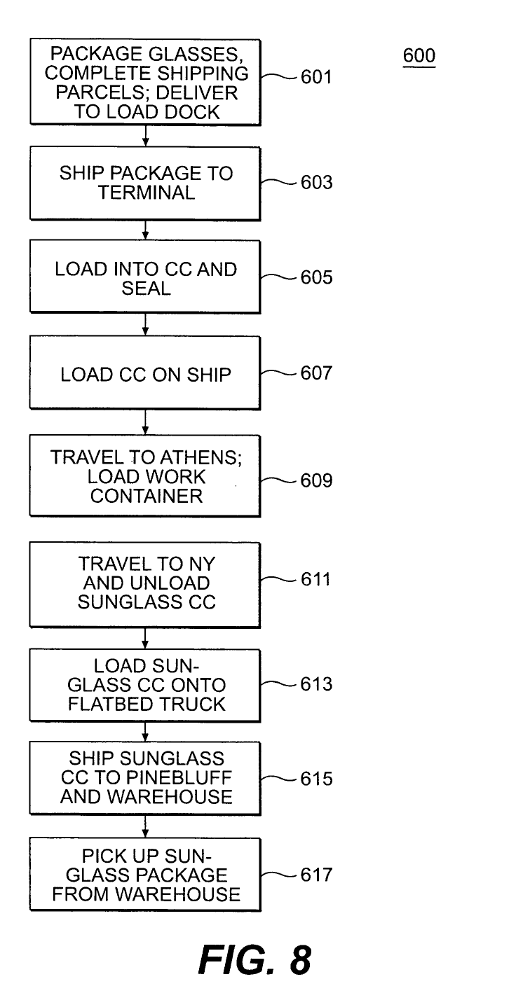

FIG. 8 is a flowchart of a transaction 600 covered by the GCCIC system 100. The transaction 600 involves a shipment of sunglasses from Marseilles, France, to Pine Bluff, Ark., by way of Athens, Greece and New York City. The sunglasses are manufactured at a small factory belonging to ShadesHut in southern France, are packaged at the factory, and are intended for a single drop off at a warehouse in Pine Bluff. The sunglasses share a cargo container with other products, from other manufacturers, destined for the Pine Bluff warehouse. In this example, Pine Bluff is a port of entry (POE).

In block 601, ShadesHut packages the glasses, completes the required shipping papers, and delivers the package to its own loading dock. ShadesHut then arranges for a trucking company (domestic carrier) to pick up the package and deliver it to a transshipment point. ShadesHut also arranges for commercial insurance, and registers the current transaction with the GCCIC system 100. The GCCIC system 100 stores details of the transaction in its current transactions section. In block 603, the trucking company loads the package and carries (drays) the package to a shipping terminal in Marseilles. In block 605, the delivered package is loaded into a cargo container, which is then sealed for shipment. In block 607, the cargo container is loaded onto a container ship, and the loading operation is sent to the GCCIC system 100, which updates the status of the current transaction.

In block 609, the cargo container is shipped to Athens, and the ship is loaded with more containers. Assuming nothing is done to the sunglasses' container, the GCCIC system 100 may only receive a notification that the ship is docked in Athens. If the cargo container is so equipped, a periodic geo-location of the container may be sent by the container to the GCCIC system 100. In block 611, the ship sails to New York City, and the container is unloaded. The GCCIC system 100 is then updated with this information. In block 613, the cargo container is loaded onto a flatbed truck of a trucking company, and the trucking company notifies the GCCIC system 100 that the cargo container is loaded and in the possession of the trucking company.

In block 615, the trucking company truck carries the cargo container to Pine Bluff and the container is warehoused in a bonded facility waiting clearance by U.S. Customs. In block 617, the wholesaler is notified by the GCCIC system 100 that the sunglasses are in the warehouse (event notification). The wholesaler arranges to pick up the sunglasses following clearance by U.S. Customs.

Other action steps besides the specific action steps shown in FIG. 8 for transaction 600 may be executed. For example, the sunglass manufacturer may prepare and file with the GCCIC system 100 an intended transaction. The intended transaction may identify the cargo, manufacturer, origin, points along the transport route, and intended shippers and other commercial entities intended to be involved in transaction 600. The intended transaction may also list any timing requirements (e.g., delivery before Memorial Day) and environmental conditions (e.g., cargo container temperature limits). As will be described later, this information may be used to perform vulnerability and risk assessments.

In addition to intended and current transaction information, the manufacturer, and others in the transport chain represented by transaction 600 may require a post-transaction analysis, or completed transaction report. A completed transaction report may be helpful for spotting trends, identifying inefficiencies, and identifying possible causes for any cargo damage (if applicable). The completed transaction information may be archived in the GCCIC system 100 information repository for later mining and analysis. In addition, the completed transaction information may be examined by government agencies to verify compliance with agency regulations, or to reconstruct an event should the need arise. Such examination may be by humans, or may be automated by electronic scanning of documents or electronic review of data in the information repository.

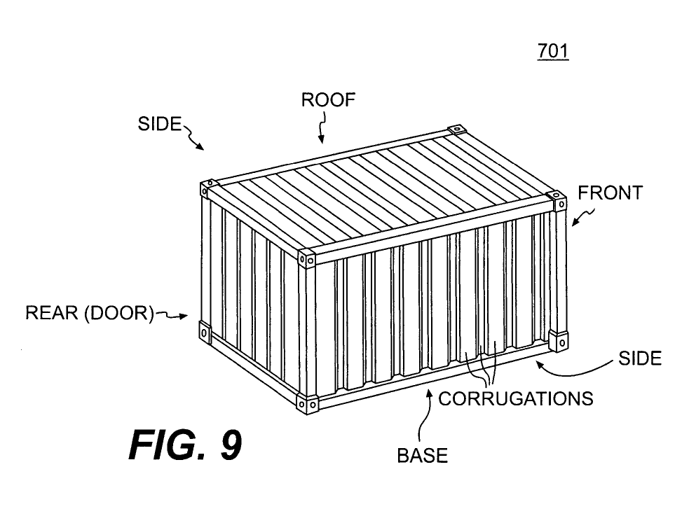

To facilitate implementation of the GCCIC 10, the CEs 110 may acquire cargo containers having specific features that allow interoperability with the GCCIC system 100. FIG. 9 shows a standard cargo container 701 that has not been adapted to support all the functionality of the GCCIC system 100. As shown, the cargo container 701 is a rectangular box having corrugated sides and top, with doors on at least one end through which cargo is loaded and unloaded. Although the cargo container 701 cannot interact with the GCCIC system 100, the cargo container 701 can be used by CEs 110 and still be in compliance with the proposed and adopted rules 200 and 210. More specifically, CE's 110 using the cargo container 701 must still follow rules, such as rules detailing manifests, customs declarations, security, traceability of goods, and other proposed and adopted rules.

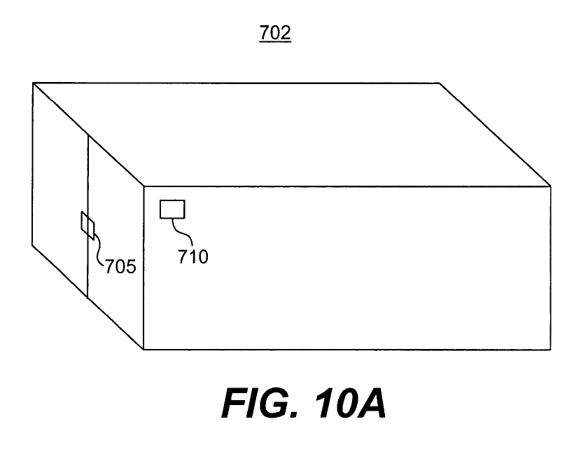

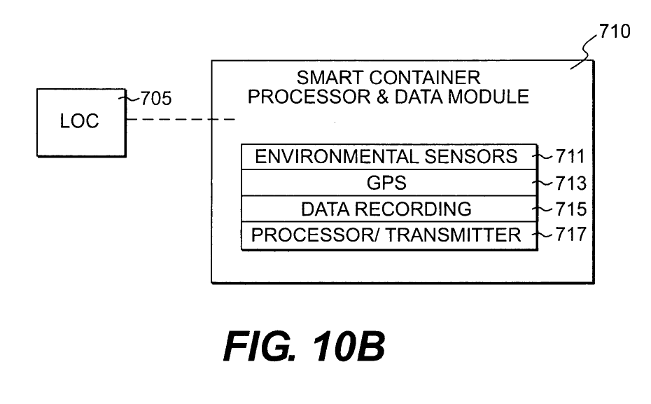

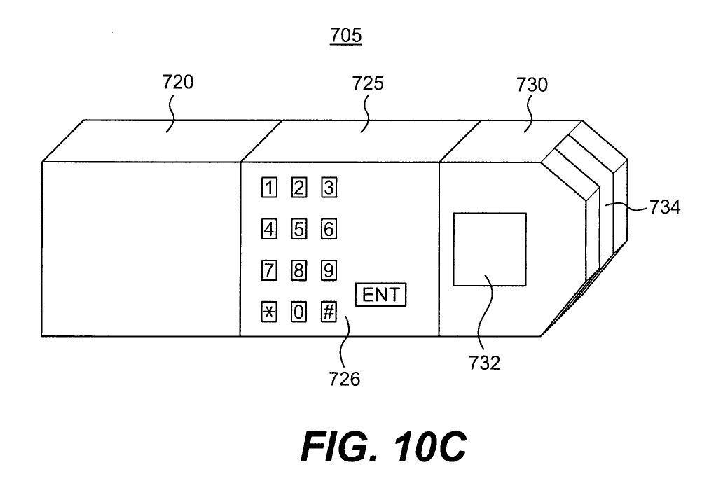

To provide partial or full operability with the GCCIC 100, an improved cargo container, such as cargo container 702 shown in FIG. 10A is used. The cargo container 702 includes an electronic lock 705 and processor and data storage module 710.

FIG. 10B shows the features of the cargo container 702 in more detail. In FIG. 10B, the processor and data storage module 710 includes environmental sensors 711, GPS section 713, data recording section 715, and processor/transmitter 717. The environmental sensors 711 are capable of measuring various environmental parameters, such as acceleration, salinity, pressure, and temperature. The measured parameters may be stored in the data recording section 715 for later retrieval. Alternatively, some or all of measured parameters may be transmitted to a remote facility using the processor/transmitter 717. By measuring and recording/transmitting environmental parameters, the cargo container 702 can generate a history of its operations as the cargo container 702 is transported from point of origin to destination. The history can be used by the GAs 120 and the CEs 110 to account for unusual conditions of the cargo container 702, including incorrectly manifested cargo, and damaged cargo, for example.

The GPS section 713 works in a manner well known to those skilled in the art to determine an accurate cargo container location. The location of the cargo container 702 may be recorded in the data recording section 715, and may be provided in real-time, near real-time, and post transaction time to a CE 110 and a GA 120, as desired.

The processor/transmitter 717 receives a signal from the lock 705. Such a signal may be provided whenever the doors to the cargo container 702 are opened or closed. The signal may be recorded and provided in real time, and may indicate abnormal operations associated with the cargo container 702.

FIG. 10C shows an embodiment of the lock 705 in more detail. The lock 705 may include lock section 720, input section 725, and access/output section 730. The lock section 720 includes electronics and mechanical devices to actuate (lock) and unlock the lock 705, thus controlling access to the cargo container 702. The input section 725 provides key pad 726 that may be used to enter passwords, user names, and other data. The access/output section includes display 732, which may be a LCD display for example, and card reader 734 that accepts and reads a contactless card. In use, an employee of a CE 110 may be issued a contactless card that can be swiped in track 734. After reading the card, the employee may be prompted through display 732 to enter a password and user name. The employee may use the keypad 726 to enter the password and user name. Once the password and user name are verified, the employee may be permitted to operate the lock 705 (for example, unlocking the lock 705).

The lock 705 may be updated remotely by signal from a CE 110 using the GCCIC system 100. For example, a CE 110 in New York may authorize an employee of a shipping company in Athens to open a cargo container by sending password and user name data to the appropriate lock 705 using the SATCOM 135 shown in FIG. 1B. Furthermore, any access by an authorized employee may be recorded by the lock 705 and the event data may then be sent to the GCCIC system 100 using the processor/transmitter 717 (FIG. 10B). Should the cargo container 702 be accessed without authorization, the lock 705 may send an unauthorized access event signal to the GCCIC system 100.

One of the services/products provided by the GCCIC 10 is a risk assessment associated with transport of a particular cargo container. The risk assessment can be used for various purposes, including setting insurance rates, notifying GAs 120 that a “risky” shipment is occurring, and notifying CEs 110 in the transport chain. Furthermore, the risk assessment may include a baseline risk assessment that is determined from initial or expected shipment parameters such as would be recorded with the GCCIC system 100 as an intended transaction. Should the shipment parameters change, the risk assessment can be updated. Associated with the risk assessment is an event notification product. That is, to provide a current risk assessment, the GCCIC system 100 may monitor events associated with movement of a cargo container, such as the events shown in FIG. 5, for example.

FIG. 1A illustrates routine 511, executed by a general purpose or specialized computer for monitoring events and providing an event notification. The routine 511 begins in block 801. In block 803, the desired reporting associated with movement of the cargo container is determined. The desired reporting may include default settings. The desired reporting may be polling, which is initiated by signal from the GCCIC system 100 to the cargo container, and may be periodic or a periodic. Alternatively, the desired reporting may be automatic, where the cargo container reports certain data on a periodic basis. Yet another reporting option involves reporting by the cargo container in reaction to certain timing or upon the occurrence of certain events. For example, a report may be generated by the cargo container when monitored environmental parameters are exceeded, when the cargo containers geographical position changes by a specified amount, or changes to a location that is not along the planned transport route for the cargo container, or when the cargo container has been in transit beyond a specified time. Finally, manual reporting, whereby members of the GCCIC association submit required reports, may be implemented for all or part of the cargo and the cargo container's transit.

The CE 110 who is the beneficial owner of the cargo in the cargo container may determine the desired reporting. Alternatively, the GCCIC association may propose and adopt reporting rules, and a GA 120 may acknowledge the reporting rules. The beneficial owner would then, to be in compliance with the GCCIC association's rules, implement the adopted reporting rules.

In block 805, the GCCIC system 100 receives environmental data from the cargo container (if the cargo container is so equipped to provide), and correlates the environmental data with various criteria, thresholds, and set points. For example, the cargo container may monitor temperature and humidity interior to the cargo container. Temperature and humidity may be critical variables for certain types of cargo, and the cargo manufacturer or the beneficial owner may establish set points or thresholds for temperature and humidity that should not bee exceeded. Many other parameters may be monitored, including, for example, salinity. In block 807, the GCCIC system 100 determines if the set point has been exceeded. If the set point has been exceeded, the GCCIC system 100 sends a report, block 809. The report of block 809 may be sent to the beneficial owner, to the shipper, to the insurer, or to other CEs 110 and GAs 120 who have an interest in knowing this status. Using the report, a shipper, for example, may take action to lower the temperature in the cargo container, an importer may refuse acceptance of the cargo from the exporter, or a government agency may determine that immate action is necessary to protect the health and safety of individuals handling the cargo container. After block 809, the routine 511 may proceed to block 823 and end. Alternately, the routine 511 may move o block 811. If in block 807, the set point is not exceeded, the routine 511 moves to block 811.

In block 811, the GCCIC system 100 receives data from the cargo container such as time checks and geographic position (if so equipped to provide) and uses the supplied data to correlate to expected events. For example, if the planned transit route places the cargo container at latitude 55 and longitude 100 on August 15 at noon, the geo position reported to the GCCIC system 100 can be used to verify that the cargo container is at its expected location. Should the reported location differ from the expected position, the GCCIC system 100 can initiate an action, such as generating a report. Thus, in block 813, the GCCIC system 100 determines if the monitored event exceeds any pre-established criteria. If the criteria is exceeded, the GCCIC system 100 sends a report to appropriate entities, block 815. The routine 511 may then move to block 823 and end, or the routine 511 may continue with processing. In block 813, if the criteria is not exceeded, the routine moves to block 817, and determines if (when) the cargo container is opened. If the cargo container is opened, the routine 511 moves to block 819, and the GCCIC system 100 determines if the opening was authorized. If the opening was not authorized, the routine 511 moves to block 821 and sends a report. The routine 511 then ends, or continues monitoring, returning the block 805. In block 819, if the opening was authorized, the routine 511 moves to block 823 and ends; alternately, the routine 511 returns to block 803 and continues monitoring. In block 817, if the cargo container was not opened, the routine 511 moves to block 823 and ends, or returns to block 805 and continues monitoring.

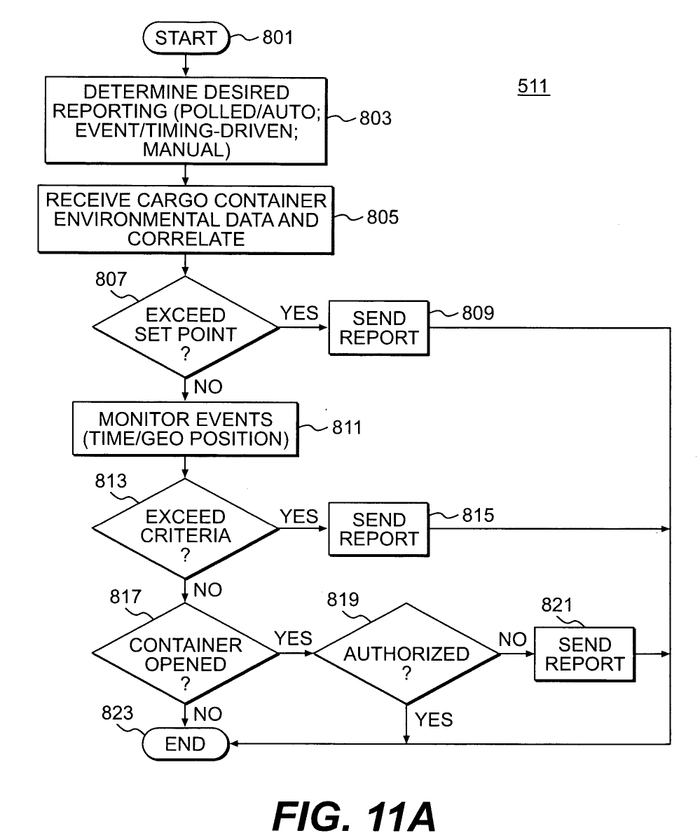

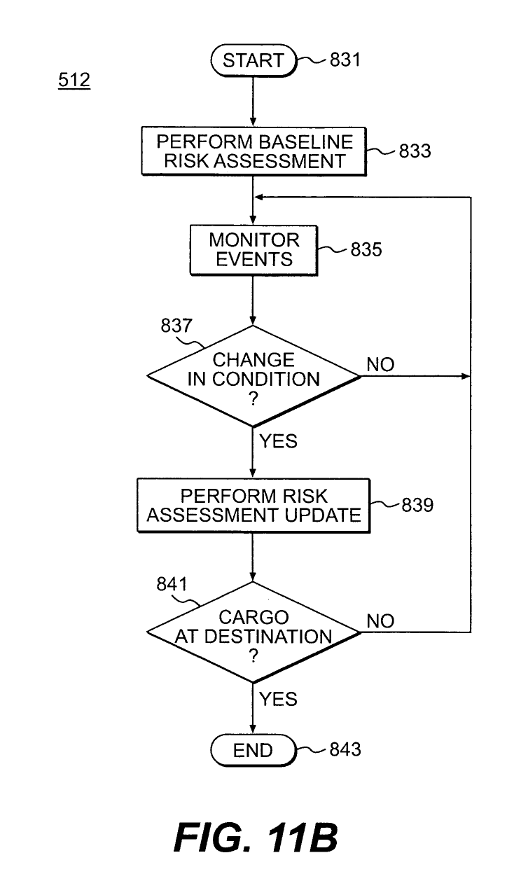

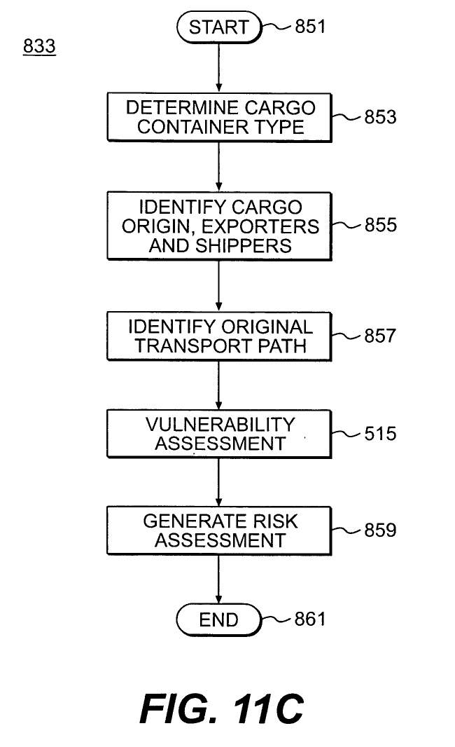

Event monitoring, and collection of data from an in-transit cargo container can be used for risk assessment purposes. FIG. 11B illustrates an embodiment of risk assessment routine 512. The routine 512 starts in block 831. In block 833, a baseline risk assessment calculation is performed by the GCCIC system 100, and the results are provided to appropriate members of the GCCIC. The baseline risk assessment calculation 833 will be described in more detail with reference to FIG. 11C. In block 835, the GCCIC system 100 monitors events related to the cargo container (and its cargo) for which the baseline risk assessment was completed. Such monitoring can follow the routine 511 shown in FIG. 11A, for example. In block 837, the GCCIC system 100 determines if an event, or reported data, provides enough of a change in the status of the cargo container to warrant an update to the risk assessment. If there is not change, or only a small change, the routine 512 returns to block 835, and the GCCIC system 100 continues monitoring. If the change is sufficient, the routine 512 moves to block 839 and the GCCIC system 100 updates the risk assessment. The updated risk assessment is then reported and may be used to revise insurance rates, or to invoke inspections by a government agency, for example. In block 841, the GCCIC system 100 determines if the cargo container has reached its final destination and the bulk cargo is broken out, at which point the routine 512 ends, block 843.

FIG. 11C illustrates an embodiment of baseline risk assessment calculation routine 833. The routine 833 begins in block 851. In block 853, the GCCIC system 100 determines the type of cargo container for which the risk assessment is being performed. For example, the cargo container can be a standard container such as the container 701 shown in FIG. 9 or an advanced (smart) container such as the cargo container 702 shown in FIG. 10A. Use of a smart cargo container will usually result in a more favorable risk assessment. In block 855, the type and quantity of cargo is identified, along with the country of origin, manufacturer, domestic carriers, and shippers. Using commercial entities that are members of the GCCIC association for transport of the cargo container will usually result in a more favorable risk assessment. Further, GCCIC governing rules may require that only GCCIC association members be used, unless such members are not available.

In block 857, the intended, or original itinerary for the cargo container is identified. This includes interim stops, days in transit, interim storage, and other factors that affect the cargo container's transportation route. Next, vulnerability assessment 515 is completed. The vulnerability assessment 515 may consider factors such as country of origin, interim stops, threat levels, planned transit routes, and type of cargo, for example. In block 859, the baseline risk assessment is completed. The routine 833 then ends.

In addition to reviewing intended, current and completed transactions, and tracking the movement of cargo containers, the GCCIC system 100 may be used to collect information related to the CEs 110 and their employees. Such information may be used to rate each of the CEs 110 from a security and reliability perspective. The information may include employee data such as nationality, citizenship, date of birth, and other personal information, employment, legal, and financial history, and any security information including security clearances, denials, charges, and investigations. Similarly, each CE 110 may be required, as a condition for membership in the GCCIC association, to furnish the GCCIC system with corporate information such as corporate legal and financial status, ownership history and identification of related companies, partnerships and associations, corporate legal history, including criminal and civil actions completed or pending against the corporation, and corporate security and safety information.

Finally, the GCCIC system 100 may record information related to each and every cargo container used in the GCCIC 10. Such information may include the manufacturer, owner and lessor of the cargo container, and any cargo container history that would impact its use in the GCCIC 10, including any damage, theft, or other problems associated with the cargo container. In addition, the GCCIC system 100 may record technical data related to the cargo container, including its monitoring, safety, and security features and capabilities.

1. A Global Cargo Container Information Clearinghouse (GCCIC), comprising:
a GCCIC system having a central information repository wherein information related to the transportation of goods is processed and stored, the repository, comprising:
a processor section including routines to operate the GCCIC,
a transaction section that tracks transactions recorded in the GCCIC, and
a data section that records the information and provides an interface to users of the GCCIC; and
a set of rules for operation of the GCCIC, wherein one or more rules is acknowledged by a government agency.

2. The GCCIC system of claim 1, further comprising a mutual benefit association including commercial entities and government agencies, wherein the commercial entities propose the one or more rules to be acknowledged by the government agency, and wherein the commercial entities and the government agencies provide information to the GCCIC system and receive information and products from the GCCIC system.

3. The GCCIC system of claim 1, wherein the products provided from the GCCIC system comprise risk assessments, data mining, transaction insurance, data archiving and trend analysis, vulnerability assessments, customized reporting, and regulatory and compliance assessments.

4. The GCCIC system of claim 1, further comprising:
an incentives program to encourage compliance with the set of rules for operation of the GCCIC; and
an enforcement program to ensure compliance with the set of rules.

5. A Cargo Container Information Clearinghouse (GCCIC), comprising:
a non-profit association;
a set of rules for operation of the GCCIC system, wherein the set of rules for operation of the GCCIC system include rules specifying information to be maintained in the central information repository;
GCCIC association members, comprising commercial entities and government agencies involved in trade of goods across national borders;
a set of rules for governing the GCCIC association members, wherein one or more rules is acknowledged by a government agency;
an enforcement mechanism operable to enforce the set of rules for governing the GCCIC association members; and
a set of initiatives and programs that encourage membership in the GCCIC association.

6. The GCCIC of claim 5, further comprising a GCCIC operating entity that administers the GCCIC system, wherein the commercial entities pay a fee for services and products provided through the operating entity, and wherein the operating entity is paid for administering the GCCIC system.

7. The GCCIC of claim 5, further comprising a GCCIC service provider that provides technical assistance and products usable by members of the GCCIC operating entity.

8. A method for operation of a Cargo Container Information Clearinghouse (GCCIC), comprising:
providing a GCCIC system including a central information repository;
providing a set of rules for operating the GCCIC system;
forming a GCCIC association comprising commercial entities and government agencies as members;
proposing rules for governing the association;
receiving an indication that the proposed rules are acknowledged by a government agency;
providing incentives and programs for members of the association;
imposing fees on the organization; and
monitoring compliance with the adopted rules.

9. The method of claim 8, wherein providing the incentives and programs comprises providing reduced insurance rates based on compliance with the adopted rules.

10. The method of claim 9, further comprising conducting a risk assessment related to the transportation of goods in cargo containers across national borders, wherein the risk assessment is usable to lower insurance rates.

11. A method for controlling shipment of cargo containers, comprising:
forming a not-for-profit association of commercial entities and government agencies concerned with movement of cargo containers across national borders;
proposing rules for governing the association, wherein one or more of the rules are acknowledged by a government agency;
establishing a cargo container clearinghouse system comprising:
processing to process cargo container shipment transactions, and
data storage to store information related to the transactions;
setting rules for operation of the cargo container clearinghouse system, wherein the cargo container clearinghouse system is operated by a commercial entity on a for-profit basis;
providing incentives for compliance with the governing rules; and
monitoring compliance with the governing rules.

12. The method of claim 11, further comprising establishing a service provider to provide technical advice and components as needed to comply with the governing rules and the rules for operation of the cargo container clearinghouse system.

13. The method of claim 12, wherein the components comprise electronic locks and tags, wherein the electronic locks and tags are useable to report cargo container status reports to the cargo container clearinghouse system.

14. The method of claim 11, wherein providing incentives comprises:
providing cargo container risk assessments;
providing transaction insurance based on the cargo container risk assessments;
providing transaction data storage and access;
providing customized reporting of cargo container transactions;
providing event notifications; and
providing regulatory and compliance assessments.

15. The method of claim 11, wherein monitoring compliance comprises:
tracking cargo container events;
receiving cargo container status reports; and
reviewing completed cargo container transactions.

16. The method of claim 15, wherein tracking cargo container events comprises:
tracking cargo container openings;
tracking cargo container time in transit; and
tracking cargo container geo position.

17. The method of claim 15, wherein receiving cargo container status reports comprise:
receiving cargo container geo positions; and
receiving cargo container environmental information.

18. The method of claim 17, further comprising:
correlating the cargo container status reports with related threshold information from a cargo container intended transit plan; and
sending an alert when a threshold is exceeded.

19. The method of claim 18, further comprising generating an updated risk assessment when a threshold is exceeded.

20. The method of claim 11, further comprising, for a cargo container transaction, performing a vulnerability assessment, comprising:
(a) determining a cargo container type;
(b) identifying cargo, origin of cargo, exporter and shipper;
(c) identifying an intended transport path;
(d) assessing vulnerability based on (a)-(c).
